(19) United States
(12) Patent Application Publication
(10) Pub. No.: US 2022/0268186 A1
(43) Pub. Date: Aug. 25, 2022

(54) MUFFLER FOR ENGINE, AIR-COOLED ENGINE, AND WORK MACHINE

(71) Applicant: HONDA MOTOR CO., LTD., Tokyo (JP)

(72) Inventors: Shingo TSURUOKA, Saitama (JP); Atsuki SUGIHARA, Saitama (JP); Ryo SAITO, Saitama (JP)

(21) Appl. No.: 17/676,277

(22) Filed: Feb. 21, 2022

(30) Foreign Application Priority Data
Feb. 25, 2021 (JP) 2021-028936

(51) Int. Cl. F01N 1/00; G10K 11/16

(52) U.S. Cl. CPC F01N 1/006; G10K 11/161

(57) ABSTRACT

A muffler for an engine includes: a muffler body provided with a muffling chamber; a discharge pipe configured to discharge exhaust gas that has passed through the muffling chamber to an external space, wherein a downstream edge of the discharge pipe in an exhaust direction is shaped into a wave that is continuous in a circumferential direction.

### TECHNICAL FIELD

The present invention relates to a muffler for an engine, an air-cooled engine, and a work machine.

### BACKGROUND ART

Conventionally, an engine is provided with an exhaust device for discharging exhaust gas generated in a combustion process. The exhaust device includes an exhaust pipe through which the exhaust gas passes, a catalyst configured to purify the exhaust gas, a muffler configured to reduce an exhaust sound of the engine, and the like. For example, the exhaust gas generated in the combustion process passes through the exhaust pipe, the catalyst, and the muffler in this order, and then is discharged to an outside of the engine.

The noise caused by the exhaust sound of the engine has been a long-standing problem, and various research and development have been carried out to suppress the noise. For example, JP2008-138608A discloses an exhaust muffling device in which an expansion chamber is filled with a sound absorbing material.

In general, the above-mentioned sound absorbing material effectively attenuates a high frequency component (that is, a component having a relatively high frequency) of the exhaust sound, but cannot effectively attenuate a low frequency component (that is, a component having a relatively low frequency) of the exhaust sound. Accordingly, the exhaust muffling device disclosed in JP2008-138608A may not be able to sufficiently reduce the noise caused by the exhaust sound.

If the volume of a muffling chamber in the muffler is increased, not only the high frequency component of the exhaust sound but also the low frequency component of the exhaust sound can be attenuated. However, if the volume of the muffling chamber is increased in this way, the size of the muffler is also increased, and thus it may be difficult to mount the muffler on a relatively small engine such as a general-purpose engine.

### SUMMARY OF THE INVENTION

In view of the above background, an object of the present invention is to effectively attenuate a low frequency component of an exhaust sound of an engine without increasing the size of a muffler.

To achieve such an object, one aspect of the present invention provides a muffler (41) for an engine (1), comprising: a muffler body (94) provided with a muffling chamber (111 to 113); a discharge pipe (99) configured to discharge exhaust gas that has passed through the muffling chamber to an external space (S), wherein a downstream edge (99b) of the discharge pipe in an exhaust direction is shaped into a wave that is continuous in a circumferential direction.

According to this aspect, it is possible to effectively attenuate a low frequency component of an exhaust sound of the engine without increasing the size of the muffler.

In the above aspect, preferably, the downstream edge of the discharge pipe in the exhaust direction protrudes to one side of the muffler body in a longitudinal direction thereof.

According to this aspect, it is possible to prevent the downstream edge of the discharge pipe in the exhaust direction from protruding from an outer circumferential surface of the muffler body. Accordingly, it is possible to more effectively suppress an increase in the size of the muffler.

In the above aspect, preferably, the discharge pipe extends in a longitudinal direction of the muffler body and penetrates the muffler body to protrude to both sides of the muffler body in the longitudinal direction thereof, and a pair of openings (125) are provided at both ends of the discharge pipe in a longitudinal direction thereof.

According to this aspect, it is possible to flexibly select the direction in which the discharge pipe discharges the exhaust gas from among one side of the muffler body in the longitudinal direction thereof, the other side of the muffler body in the longitudinal direction thereof, and both sides of the muffler body in the longitudinal direction thereof.

In the above aspect, preferably, the discharge pipe is bent at a portion (99c) protruding to one side of the muffler body in the longitudinal direction thereof.

According to this aspect, the flexibility in the direction in which the discharge pipe discharges the exhaust gas can be enhanced, so that the usability of the work machine on which the muffler is installed is improved.

In the above aspect, preferably, the muffler body includes: a tubular portion (101) extending in a longitudinal direction of the muffler body: and a pair of lid portions (102) covering openings (101A) at both ends of the tubular portion, the discharge pipe includes: a first pipe portion (99X) extending in the longitudinal direction of the muffler body and penetrating one of the lid portions to protrude from the muffler body; and a second pipe portion (99Y) bent from the first pipe portion inside the muffler body and penetrating the tubular portion to protrude from the muffler body, and an opening is provided in a protruding portion of each of the first pipe portion and the second pipe portion, the protruding portion protruding from the muffler body.

According to this aspect, the flexibility in the direction in which the discharge pipe discharges the exhaust gas can be enhanced, so that the usability of the work machine on which the muffler is installed is improved.

In the above aspect, preferably, the downstream edge of the discharge pipe in the exhaust direction is provided on an outer circumference of one of the openings, and another of the openings is closed by a lid member (126).

According to this aspect, it is possible to determine the direction in which the discharge pipe discharges the exhaust gas with a simple configuration.

In the above aspect, preferably, an outer circumference of the downstream edge of the discharge pipe in the exhaust direction is covered with a cover (129).

According to this aspect, it is possible to suppress the damage of the downstream edge of the discharge pipe in the exhaust direction and enhance the muffling effect.

In the above aspect, preferably, a plurality of first curving portions (99b1) and a plurality of second curving portions (99b2) are alternately formed on the downstream edge of the discharge pipe in the exhaust direction, the first curving portions being recessed to an upstream side in the exhaust direction, the second curving portions protruding to a downstream side in the exhaust direction.

According to this aspect, a corner (a sharp portion) is not formed on the downstream edge of the discharge pipe in the exhaust direction. Accordingly, even if the downstream edge of the discharge pipe in the exhaust direction comes into contact with other parts at the attachment of the muffler or the like, the downstream edge of the discharge pipe in the exhaust direction is less likely to deform.

In the above aspect, preferably, a radius of curvature of the second curving portions is smaller than a radius of curvature of the first curving portions.

According to this aspect, circumferential distances between the second curving portions become wider, so that the downstream edge of the discharge pipe in the exhaust direction can be easily shaped into a wave.

In the above aspect, preferably, a radius of curvature of the second curving portions is equal to or greater than a radius of curvature of the first curving portions.

According to this aspect, the circumferential width of each second curving portion increases, and thus each second curving portion is less likely to deform even if each second curving portion comes into contact with other parts at the attachment of the muffler or the like.

To achieve such an object, another aspect of the present invention provides an air-cooled engine (1) comprising the muffler.

In general, an air-cooled engine is smaller than a water-cooled engine or the like, and thus the muffler according to the present invention, which is small and has a high muffling performance, is suitable for the air-cooled engine.

To achieve such an object, still another aspect of the present invention provides a work machine (P) comprising the muffler or the air-cooled engine.

According to this aspect, it is possible to effectively attenuate a low frequency component of an exhaust sound of the engine without increasing the size of the work machine.

Thus, according to the above aspects, it is possible to effectively attenuate a low frequency component of an exhaust sound of an engine without increasing the size of a muffler.

### BRIEF DESCRIPTION OF THE DRAWING(S)

FIG. 1 is a side view showing a V-type engine according to the first embodiment of the present invention;

FIG. 2 is a rear view showing the V-type engine according to the first embodiment of the present invention;

FIG. 3 is a perspective view showing an engine body and an air cleaner according to the first embodiment of the present invention;

FIG. 4 is an exploded perspective view showing the V-type engine according to the first embodiment of the present invention;

FIG. 5 is an exploded perspective view showing the V-type engine according to the first embodiment of the present invention;

FIG. 6 is a cross-sectional view showing a catalyst pipe according to the first embodiment of the present invention;

FIG. 7 is a cross-sectional view showing a muffler according to the first embodiment of the present invention;

FIG. 8A is a front view showing the shape of a first example of a discharge pipe according to the first embodiment of the present invention;

FIG. 8B is a front view showing the shape of a second example of a discharge pipe according to the first embodiment of the present invention;

FIG. 8C is a front view showing the shape of a third example of a discharge pipe according to the first embodiment of the present invention;

FIG. 9 is a graph showing a relationship between frequency and sound pressure when the V-type engine is driven according to the first embodiment of the present invention;

FIG. 10 is a rear view showing a V-type engine according to another embodiment of the present invention;

FIG. 11 is a cross-sectional view showing a muffler according to still another embodiment of the present invention;

FIG. 12 is a cross-sectional view showing a muffler according to still another embodiment of the present invention;

FIG. 13 is a side view showing a V-type engine according to the second embodiment of the present invention;

FIG. 14 is a bottom view showing the V-type engine according to the second embodiment of the present invention;

FIG. 15 is an exploded perspective view showing the V-type engine according to the second embodiment of the present invention; and

FIG. 16 is an exploded perspective view showing the V-type engine according to the second embodiment of the present invention.

### DETAILED DESCRIPTION OF THE INVENTION

### The First Embodiment

### <V-Type Engine 1>

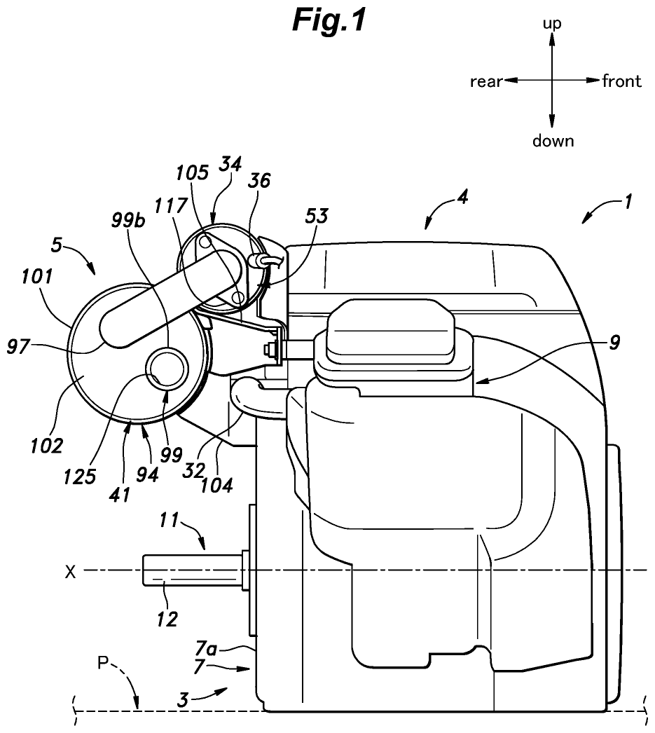

First, a horizontal V-type engine 1 (hereinafter abbreviated as “engine 1”) as an internal combustion engine according to the first embodiment of the present invention will be described with reference to FIGS. 1 to 7. Hereinafter, for convenience of explanation, a right side in FIG. 1 is defined as a front side of the engine 1. Further, in this specification, when an expression like “fixed by bolt(s) (not shown)” is used, a member may be fixed by normal bolt(s) having a screw on only one side or by stud bolt(s) having screws on both sides.

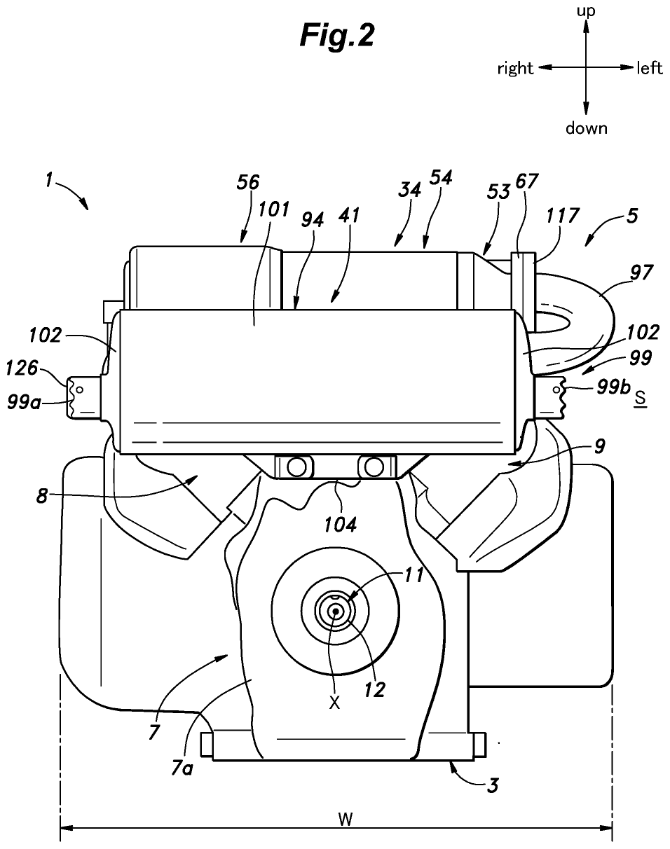

With reference to FIGS. 1 and 2, the engine 1 consists of a general-purpose engine used as a power source of a work machine P. For example, the work machine P consists of a cutting machine such as a concrete cutter, a floor treatment machine such as a floor leveler, a high-pressure washer, a generator, or the like. The engine 1 consists of an OHV air-cooled engine including two cylinders. In another embodiment, the engine 1 may consist of an engine (for example, an OHC engine) other than an OHV engine, an engine (for example, a water-cooled engine) other than an air-cooled engine, or an engine including three or more cylinders. Further, in another embodiment, the engine 1 may consist of a multicylinder engine (for example, an in-line engine) other than a V-type engine or a single-cylinder engine.

The engine 1 includes an engine body 3, an air cleaner 4 arranged above the engine body 3, an exhaust device 5 arranged on an upper rear side of the engine body 3. In the following, these components of the engine 1 will be described in order.

### <Engine Body 3>

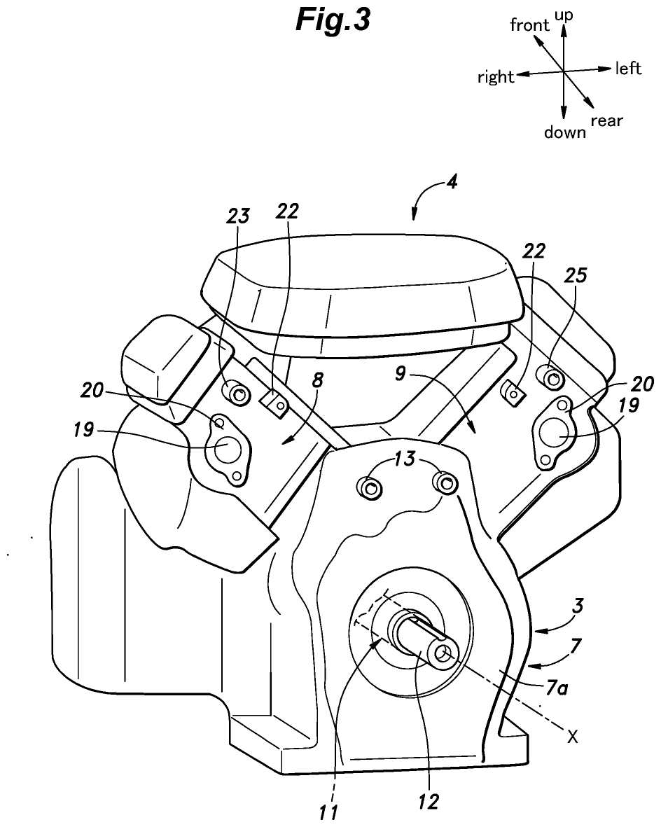

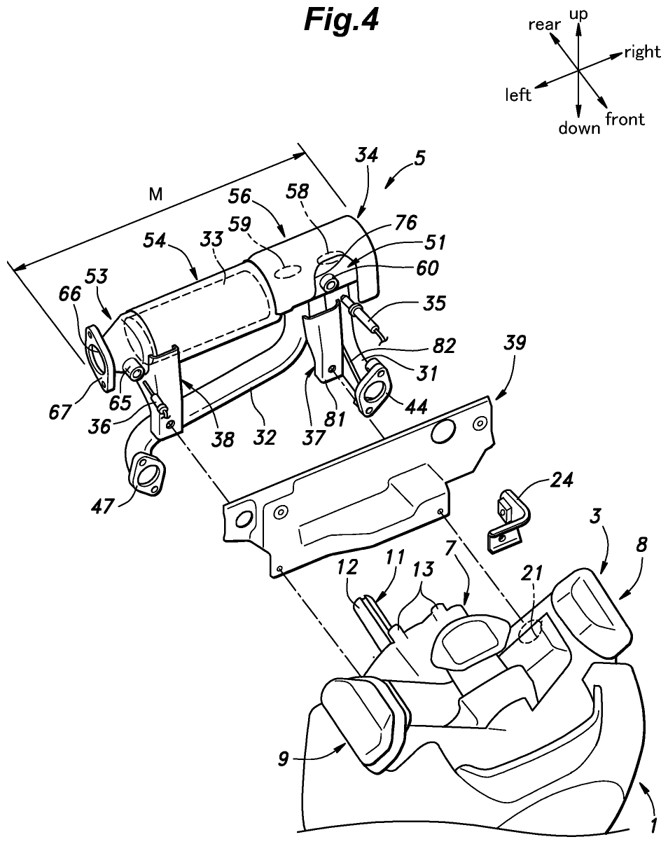

With reference to FIGS. 3 and 4, the engine body 3 includes a crankcase 7, a first cylinder bank 8 extending to an upper right side from the crankcase 7, and a second cylinder bank 9 extending to an upper left side from the crankcase 7.

A crankshaft 11 is rotatably supported by a central portion of the crankcase 7. The crankshaft 11 is configured to rotate around a rotation axis X extending in the front-and-rear direction. That is, the engine 1 consists of a horizontal engine in which the rotation axis X of the crankshaft 11 extends in the horizontal direction. A power take-off shaft 12 (PTO shaft: an example of an output portion) is provided at a rear end of the crankshaft 11. The PTO shaft 12 is connected to a work unit of the work machine P (for example, a blade of the concrete cutter), and the work unit of the work machine P is configured to rotate according to the rotation of the PTO shaft 12. The PTO shaft 12 protrudes rearward from a rear surface 7a (one side surface) of the crankcase 7 and extends in the front-and-rear direction. A pair of left and right first fixed bosses 13 are provided on an upper portion of the rear surface 7a of the crankcase 7.

The first and second cylinder banks 8, 9 are aligned in the lateral direction (the width direction of the engine body 3). Each of the first and second cylinder banks 8, 9, is provided diagonally above the crankcase 7.

In a lower portion (cylinder) of each of the first and second cylinder banks 8, 9, a piston (not shown) is accommodated so as to reciprocate. The piston is connected to the crankshaft 11 via a connecting rod (not shown).

An upper portion (cylinder head) of each of the first and second cylinder banks 8, 9 defines a combustion chamber (not shown) together with the piston. On a laterally inner surface of the upper portion of each of the first and second cylinder banks 8, 9, an intake port (not shown) communicating with the combustion chamber opens. On a rear surface of the upper portion of each of the first and second cylinder banks 8, 9, an exhaust port 19 communicating with the combustion chamber opens and a flange surface 20 is formed around the exhaust port 19. In the upper portion of the first cylinder bank 8, a temperature sensor 21 (see FIG. 4) configured to detect temperature thereof is arranged. In another embodiment, temperature sensors 21 may be arranged in both the first and second cylinder banks 8 and 9, or may not be arranged in either of the first and second cylinder banks 8 and 9.

On the rear surface of the upper portion of each of the first and second cylinder banks 8 and 9, a second fixed boss 22 is provided on a laterally inner side of the flange surface 20. On the rear surface of the upper portion of the first cylinder bank 8, a third fixed boss 23 is provided above the flange surface 20. An L-shaped attachment plate 24 (see FIG. 4) is fixed to the third fixed boss 23 by a bolt (not shown). On the rear surface of the upper portion of the second cylinder bank 9, a fourth fixed boss 25 is provided above the flange surface 20.

### <Air Cleaner 4>

With reference to FIG. 3, the air cleaner 4 has a flat shape (flat plate-like shape) elongated in the lateral direction and the front-and-rear direction. The air cleaner 4 is arranged between the first and second cylinder banks 8, 9 of the engine body 3. The air cleaner 4 is connected to the intake port (not shown) of each of the first and second cylinder banks 8, 9 via an intake pipe (not shown), and thus the air cleaned by the air cleaner 4 is introduced into the combustion chamber (not shown) via the intake port.

### <Exhaust Device 5>

The exhaust device 5 is a device configured to discharge the exhaust gas discharged from the engine body 3 to an outside of the engine 1. Hereinafter, an expression “upstream” and an expression “downstream” indicate “upstream” and “downstream” in an exhaust direction (namely, a direction in which the exhaust gas flows inside the exhaust device 5) respectively. One-dot chain line arrows appropriately attached to each figure indicate the exhaust direction.

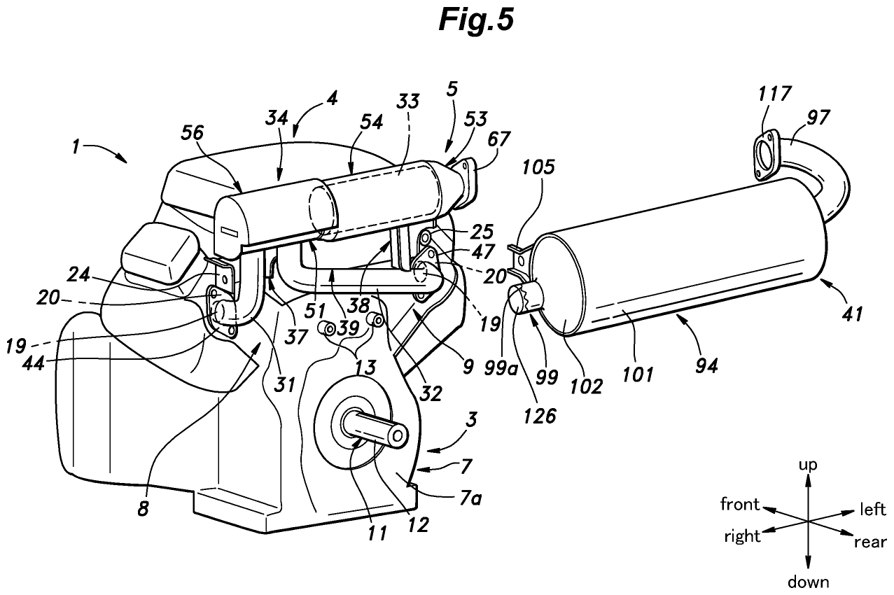

With reference to FIGS. 4 and 5, the exhaust device 5 includes first and second exhaust pipes 31, 32, a catalyst 33, a catalyst pipe 34, an oxygen sensor 35, a temperature sensor 36, first and second reinforcement members 37, 38, a thermal insulation member 39, and a muffler 41 for the engine 1 (hereinafter abbreviated as “muffler 41”). In the following, these components of the exhaust device 5 will be described in order.

### <First and Second Exhaust Pipes 31, 32>

With reference to FIGS. 4 and 5, the first and second exhaust pipes 31, 32 of the exhaust device 5 are arranged at a rear side of the engine body 3 and aligned in the lateral direction. An inner diameter of each of the first and second exhaust pipes 31, 32 is larger than an inner diameter of the exhaust port 19 of each of the first and second cylinder banks 8 and 9. The second exhaust pipe 32 is longer than the first exhaust pipe 31.

The first exhaust pipe 31 curves and extends from a lower side to an upper side. On an outer circumference of a lower end (upstream end) of the first exhaust pipe 31, a first fixed flange 44 is provided. The first fixed flange 44 is fixed to the flange surface 20 of the first cylinder bank 8 by a pair of bolts (not shown). Accordingly, the lower end of the first exhaust pipe 31 is connected to the exhaust port 19 of the first cylinder bank 8.

A left portion (upstream portion) of the second exhaust pipe 32 curves and extends from a left side to a right side. A laterally central portion of the second exhaust pipe 32 extends linearly from a left side to a right side. A right portion (downstream portion) of the second exhaust pipe 32 curves and extends from a lower side to an upper side. On an outer circumference of a left end (upstream end) of the second exhaust pipe 32, a second fixed flange 47 is provided. The second fixed flange 47 is fixed to the flange surface 20 of the second cylinder bank 9 by a pair of bolts (not shown). Accordingly, the left end of the second exhaust pipe 32 is connected to the exhaust port 19 of the second cylinder bank 9.

### <Catalyst 33>

With reference to FIGS. 4 and 5, the catalyst 33 of the exhaust device 5 has a columnar shape elongated in the lateral direction. That is, in the present embodiment, the longitudinal direction of the catalyst 33 matches the lateral direction. For example, the catalyst 33 consists of a ternary catalyst. The catalyst 33 is configured to purify the exhaust gas by changing a harmful substance in the exhaust gas, which is discharged from the engine body 3 via the first and second exhaust pipes 31, 32, into a harmless substance by a chemical reaction.

### <Catalyst Pipe 34>

With reference to FIG. 1, the catalyst pipe 34 of the exhaust device 5 is arranged adjacently to the air cleaner 4 on a rear side of the air cleaner 4. The catalyst pipe 34 is arranged above the PTO shaft 12, and protrudes more rearward (sideward) than the rear surface 7a (one side surface) of the crankcase 7. An outer surface (a surface facing away from a surface opposed to the engine body 3) of the catalyst pipe 34 is covered with a cover (not shown).

With reference to FIG. 2, the catalyst pipe 34 is arranged adjacently to the first and second cylinder banks 8 and 9. The catalyst pipe 34 extends in the lateral direction from an upper end side (distal end side) of the first cylinder bank 8 to an upper end side (distal end side) of the second cylinder bank 9. When viewed in the front-and-rear direction (axial direction of the crankshaft 11), the catalyst pipe 34 is arranged within a width W of the engine body 3.

With reference to FIGS. 4 to 6, the catalyst pipe 34 has a cylindrical shape (an example of a tubular shape) elongated in the lateral direction. That is, in the present embodiment, the longitudinal direction of the catalyst pipe 34 matches the lateral direction. In another embodiment, the catalyst pipe 34 may have a shape (for example, a polygonal tubular shape) other than a cylindrical shape. The catalyst pipe 34 is arranged on a downstream side of the first and second exhaust pipes 31, 32. The catalyst pipe 34 accommodates the catalyst 33.

The catalyst pipe 34 includes an inlet tubular body 51, an inner tubular body 52, an outlet tubular body 53, an outer tubular body 54, a lid body 55, and a cover body 56. An arrow M in FIG. 4 indicates a lateral range (a range from a left end of the outlet tubular body 53 to a right end of the cover body 56) of the catalyst pipe 34. Inner diameters of the inlet tubular body 51, the inner tubular body 52, and the outlet tubular body 53 (namely, inner diameters of portions of the catalyst pipe 34 through which the exhaust gas flows) are larger than an inner diameter of the exhaust port 19 of each of the first and second cylinder banks 8 and 9.

The inlet tubular body 51 extends in the lateral direction. On a lower surface of the inlet tubular body 51, first and second inlet ports 58, 59 of the exhaust gas are arranged at intervals in the lateral direction. On a right side (upstream side) of the catalyst 33, an upper end (downstream end) of the first exhaust pipe 31 is connected to the first inlet port 58. On a right side (upstream side) of the catalyst 33, a right end (downstream end) of the second exhaust pipe 32 is connected to the second inlet port 59.

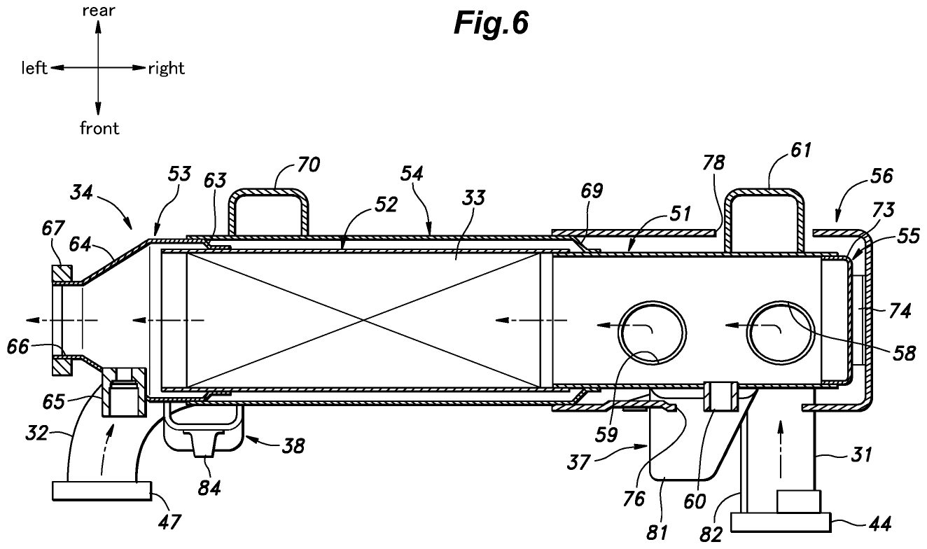

On a front surface (a surface opposed to the first and second inlet ports 58, 59) of the inlet tubular body 51, a first attachment boss 60 is provided. The first attachment boss 60 is arranged more leftward than the first inlet port 58 and more rightward than the second inlet port 59. That is, the first attachment boss 60 is arranged between the first inlet port 58 and the second inlet port 59 in the lateral direction. On an outer circumferential surface of the inlet tubular body 51, a fixed piece 61 protrudes rearward. Incidentally, the fixed piece 61 is omitted from the drawings except FIG. 6.

The inner tubular body 52 extends in the lateral direction. The inner tubular body 52 is arranged on a left side (downstream side) of the inlet tubular body 51. An inner circumference of a right end of the inner tubular body 52 is fixed to an outer circumference of a left end of the inlet tubular body 51 by welding. The inner tubular body 52 covers an outer circumference of the catalyst 33. An inner circumferential surface of the inner tubular body 52 is fixed to an outer circumferential surface of the catalyst 33 by welding.

The outlet tubular body 53 extends in the lateral direction. The outlet tubular body 53 is arranged on a left side (downstream side) of the inner tubular body 52. On a right portion of the outlet tubular body 53, a first diameter reduced portion 63 is provided. The diameter of the first diameter reduced portion 63 is reduced from a left side (downstream side) to a right side (upstream side). At a right side (upstream side) of the first diameter reduced portion 63, a left portion of the inner tubular body 52 is fitted into a right end of the outlet tubular body 53 so as to slide relative to the right end of the outlet tubular body 53. In a laterally central portion of the outlet tubular body 53, a tapered portion 64 is provided. The diameter of the tapered portion 64 is reduced from a right side (upstream side) to a left side (downstream side). On a front surface of the tapered portion 64, a second attachment boss 65 is provided. At a left end of the outlet tubular body 53, an outlet port 66 of the exhaust gas is provided. On an outer circumference of the outlet port 66, a connecting flange 67 is provided. The connecting flange 67 is fixed to the left end of the outlet tubular body 53 by welding.

The outer tubular body 54 extends in the lateral direction. The outer tubular body 54 is arranged on an outer circumference of the inner tubular body 52. In a right portion of the outer tubular body 54, a second diameter reduced portion 69 is provided. The diameter of the second diameter reduced portion 69 is reduced from a left side (downstream side) to a right side (upstream side). On a right side (upstream side) of the second diameter reduced portion 69 and a portion where the inlet tubular body 51 and the inner tubular body 52 are welded, an inner circumference of a right end of the outer tubular body 54 is fixed to an outer circumference of a left portion of the inlet tubular body 51 by welding. On a left side (downstream side) of the first diameter reduced portion 63 of the outlet tubular body 53, an inner circumference of a left end of the outer tubular body 54 is fixed to an outer circumference of a right portion of the outlet tubular body 53 by welding. On an outer circumferential surface of the outer tubular body 54, a fixed piece 70 protrudes rearward. Incidentally, the fixed piece 70 is omitted from the drawings except FIG. 6.

The lid body 55 includes a closing piece 73 and a protruding piece 74 protruding rightward from the closing piece 73. The closing piece 73 is fixed to an inner circumference of a right end (upstream end) of the inlet tubular body 51 by welding. Accordingly, the lid body 55 covers the right end of the inlet tubular body 51. The protruding piece 74 is fixed to the closing piece 73 by welding.

The cover body 56 extends in the lateral direction. The cover body 56 is arranged on an outer circumference of the inlet tubular body 51. A right end (upstream end) of the cover body 56 is fixed to the protruding piece 74 of the lid body 55 by welding. On a left side (downstream side) of the second diameter reduced portion 69 of the outer tubular body 54, a left end (downstream end) of the cover body 56 is fixed to an outer circumference of a right portion of the outer tubular body 54 by welding.

On a front surface of the cover body 56, a notch 76 is provided at a position corresponding to the first attachment boss 60 of the inlet tubular body 51. On a rear surface of the cover body 56, a hole 78 is provided at a position corresponding to the fixed piece 61 of the inlet tubular body 51. Incidentally, the hole 78 is omitted from the drawings except FIG. 6.

### <Oxygen Sensor 35>

With reference to FIG. 4, the oxygen sensor 35 of the exhaust device 5 is a sensor configured to detect the concentration of oxygen in the exhaust gas discharged from the engine body 3 via the first and second exhaust pipes 31, 32. The oxygen sensor 35 is arranged on a right side (upstream side) of the catalyst 33. The oxygen sensor 35 is attached to the first attachment boss 60 of the inlet tubular body 51 of the catalyst pipe 34, and arranged between the first inlet port 58 and the second inlet port 59 of the inlet tubular body 51 in the lateral direction.

### <Temperature Sensor 36>

With reference to FIG. 4, the temperature sensor 36 of the exhaust device 5 is a sensor configured to detect the temperature of the exhaust gas that has passed through the catalyst 33. For example, driving of the engine 1 stops when the temperature of the exhaust gas detected by the temperature sensor 36 exceeds a prescribed threshold, so that the catalyst 33 can be protected. That is, the temperature sensor 36 is a sensor for protecting the catalyst 33. The temperature sensor 36 is arranged on a left side (downstream side) of the catalyst 33. The temperature sensor 36 is attached to the second attachment boss 65 of the outlet tubular body 53 of the catalyst pipe 34.

### <First and Second Reinforcement Members 37, 38>

With reference to FIGS. 4 and 5, the first and second reinforcement members 37, 38 of the exhaust device 5 are arranged at a rear side of the engine body 3 and aligned in the lateral direction. The first and second reinforcement members 37, 38 are arranged between the catalyst pipe 34 and the thermal insulation member 39.

The first reinforcement member 37 includes a base portion 81 extending in the up-and-down direction and a protruding portion 82 protruding forward from a lower right portion of the base portion 81. A right portion of the first reinforcement member 37 is fixed to an outer circumferential surface of the first exhaust pipe 31 by welding. A left portion of the first reinforcement member 37 is fixed to an outer circumferential surface of the second exhaust pipe 32 by welding.

The second reinforcement member 38 extends in the up-and-down direction. An upper portion of the second reinforcement member 38 is fixed to outer circumferential surfaces of the outlet tubular body 53 and the outer tubular body 54 of the catalyst pipe 34 by welding. A lower portion of the second reinforcement member 38 is fixed to the outer circumferential surface of the second exhaust pipe 32 by welding.

### <Thermal Insulation Member 39>

With reference to FIGS. 4 and 5, the thermal insulation member 39 of the exhaust device 5 is arranged at a rear side of the engine body 3 and extends in the lateral direction. The thermal insulation member 39 is arranged between the catalyst pipe 34 and the air cleaner 4.

An upper right portion of the thermal insulation member 39 is fixed to the cover body 56 of the catalyst pipe 34 by a bolt (not shown). A lower right portion of the thermal insulation member 39, together with a lower portion of the base portion 81 of the first reinforcement member 37, is fixed to the second fixed boss 22 (see FIG. 3) of the first cylinder bank 8 by a bolt (not shown). An upper left portion of the thermal insulation member 39 is fixed to an upper portion of the second reinforcement member 38 by a bolt (not shown). A lower left portion of the thermal insulation member 39, together with the lower portion of the second reinforcement member 38, is fixed to the second fixed boss 22 (see FIG. 3) of the second cylinder bank 9 by a bolt (not shown).

### <Muffler 41>

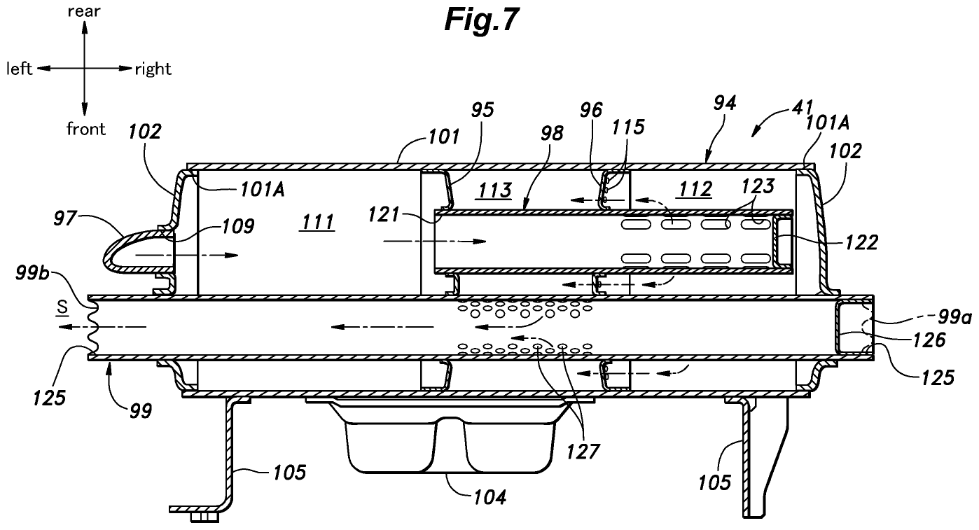

With reference to FIGS. 1 and 2, the muffler 41 of the exhaust device 5 is arranged on a downstream side of the catalyst pipe 34. The muffler 41 is not welded to the catalyst pipe 34, and is separable from the catalyst pipe 34. In another embodiment, the muffler 41 may be fixed to the catalyst pipe 34 by welding or the like. With reference to FIGS. 5 and 7, the muffler 41 includes a muffler body 94, a plurality of partition walls 95, 96, an inflow pipe 97, a communication pipe 98, and a discharge pipe 99.

With reference to FIG. 1, the muffler body 94 is arranged adjacently to the catalyst pipe 34 on a lower rear side of the catalyst pipe 34. The muffler body 94 protrudes more rearward (sideward) than the rear surface 7a (one side surface) of the crankcase 7. An outer surface (a surface facing away from a surface opposed to the engine body 3) of the muffler body 94 is covered with the abovementioned cover (not shown).

With reference to FIG. 2, the muffler body 94 is arranged parallel to the catalyst pipe 34, and extends in the lateral direction from the upper end side (distal end side) of the first cylinder bank 8 to the upper end side (distal end side) of the second cylinder bank 9. When viewed in the front-and-rear direction, an upper portion of the muffler body 94 overlaps with a lower portion of the catalyst pipe 34. When viewed in the front-and-rear direction, both lateral side portions of the muffler body 94 overlap with the upper portions of the first and second cylinder banks 8 and 9. When viewed in the front-and-rear direction, the muffler body 94 is arranged within the width W of the engine body 3.

With reference to FIGS. 5 and 7, the muffler body 94 has a cylindrical shape (an example of a tubular shape) elongated in the lateral direction. That is, in the present embodiment, the longitudinal direction of the muffler body 94 matches the lateral direction. In another embodiment, the muffler body 94 may have a shape (for example, a polygonal tubular shape) other than a cylindrical shape.

The muffler body 94 includes a tubular portion 101 extending in the lateral direction and a pair of lid portions 102 (left and right lid portions 102) covering openings 101A at both lateral ends of the tubular portion 101. In a laterally central portion on an outer circumferential surface of the tubular portion 101, a fixed bracket 104 protrudes forward. The fixed bracket 104 is fixed to the pair of left and right first fixed bosses 13 of the crankcase 7 by a pair of bolts (not shown). In both lateral side portions of the outer circumferential surface of the tubular portion 101, a pair of left and right fixed stays 105 protrude forward. The right fixed stay 105 is fixed to the attachment plate 24, which is fixed to the first cylinder bank 8, by a bolt (not shown). The left fixed stay 105 is fixed to the fourth fixed boss 25 of the second cylinder bank 9 by a bolt (not shown). On an outer circumferential surface of the tubular portion 101, a pair of left and right fixed pieces (not shown) protrude. The right fixed piece is fixed to the fixed piece 61 of the inlet tubular body 51 of the catalyst pipe 34 by a bolt (not shown). The left fixed piece is fixed to the fixed piece 70 of the outer tubular body 54 of the catalyst pipe 34 by a bolt (not shown).

A plurality of muffling chambers 111 to 113 is formed inside the muffler body 94. The muffling chambers 111 to 113 include a first muffling chamber 111 formed at a left end of the muffler body 94, a second muffling chamber 112 formed at a right end of the muffler body 94, and a third muffling chamber 113 formed between the first muffling chamber 111 and the second muffling chamber 112. Volumes of the muffling chambers 111 to 113 become smaller in order of “a volume of the first muffling chamber 111, a volume of the second muffling chamber 112, and a volume of the third muffling chamber 113”. That is, a formula “the volume of the first muffling chamber 111>the volume of the second muffling chamber 112>the volume of the third muffling chamber 113” is satisfied. An inflow port 109 of the exhaust gas is provided at a left end of the first muffling chamber 111. The inflow port 109 consists of a hole provided in the left lid portion 102.

The partition walls 95 and 96 include a first partition wall 95 laterally partitioning the first muffling chamber 111 and the third muffling chamber 113, and a second partition wall 96 laterally partitioning the second muffling chamber 112 and the third muffling chamber 113. The second partition wall 96 is provided with multiple small holes 115 over the entire area thereof, and the second muffling chamber 112 and the third muffling chamber 113 communicate with each other via these multiple small holes 115.

The inflow pipe 97 is arranged on a left side (outer side in the width direction of the engine body 3) of the muffler body 94. The inflow pipe 97 curves in a U shape to protrude to a left side (outer side in the width direction of the engine body 3). At a front end (upstream end) of the inflow pipe 97, a connecting flange 117 is provided. The connecting flange 117 is fixed to the connecting flange 67 of the outlet tubular body 53 of the catalyst pipe 34 by a pair of bolts (not shown). A rear end (downstream end) of the inflow pipe 97 is connected to the inflow port 109 of the first muffling chamber 111 of the muffler body 94. A pipe cover (not shown) is attached to an outer circumferential surface of the inflow pipe 97.

The communication pipe 98 extends in the lateral direction. The communication pipe 98 penetrates the first and second partition walls 95, 96 to be supported by the first and second partition walls 95, 96. At a left end (upstream end) of the communication pipe 98, a communication port 121 communicating with the first muffling chamber 111 is provided. To a right end (downstream end) of the communication pipe 98, a cap 122 is fixed by welding. Accordingly, the right end of the communication pipe 98 is covered with the cap 122. On an outer circumferential portion of the communication pipe 98, multiple communication holes 123 communicating with the second muffling chamber 112 are provided. According to the above configuration, the first muffling chamber 111 and the second muffling chamber 112 communicate with each other via the communication pipe 98.

The discharge pipe 99 extends in the lateral direction. The discharge pipe 99 penetrates the pair of lid portions 102 of the muffler body 94 and the first and second partition walls 95, 96 to be supported by the pair of lid portions 102 of the muffler body 94 and the first and second partition walls 95, 96. On an outer circumferential portion of the discharge pipe 99, multiple outer circumferential holes 127 communicating with the third muffling chamber 113 are provided. The left and right ends of the discharge pipe 99 protrude to both lateral sides of the muffler body 94. At left and right ends of the discharge pipe 99, a pair of openings 125 are formed. To the opening 125 formed at the right end of the discharge pipe 99, a lid member 126 is fixed by welding. Accordingly, the opening 125 formed at the right end of the discharge pipe 99 is closed by the lid member 126. The opening 125 formed at the left end of the discharge pipe 99 is not closed by a lid member 126 and communicates with an external space S on a left side of the muffler body 94. According to the above configuration, the third muffling chamber 113 and the external space S on the left side of the muffler body 94 communicate with each other via the discharge pipe 99.

A right edge 99a of the discharge pipe 99 is provided on an outer circumference of the opening 125 formed at the right end of the discharge pipe 99, and a left edge 99b (downstream edge) of the discharge pipe 99 is provided on an outer circumference of the opening 125 formed at the left end of the discharge pipe 99. The left and right edges 99a and 99b of the discharge pipe 99 protrude to both lateral sides of the muffler body 94.

With reference to FIG. 1, the left and right edges 99a and 99b (only the left edge 99b is shown in FIG. 1) of the discharge pipe 99 are arranged lower than the upper ends of the first and second cylinder banks 8 and 9 (only the second cylinder bank 9 is shown in FIG. 1). The left and right edges 99a and 99b of the discharge pipe 99 are arranged higher than a lower end of the crankcase 7.

With reference to FIG. 2, when viewed in the front-and-rear direction (axial direction of the crankshaft 11), the left and right edges 99a and 99b of the discharge pipe 99 are arranged within the width W of the engine body 3. Each of the left and right edges 99a and 99b of the discharge pipe 99 is shaped into a sine wave that is continuous in the circumferential direction of the discharge pipe 99. In another embodiment, each of the left and right edges 99a and 99b of the discharge pipe 99 may be shaped into a wave (for example, a sawtooth wave or a pulse wave) other than a sine wave. Further, in still another embodiment, only one of the right edge 99a and the left edge 99b (namely, only one edge corresponding to a downstream edge) of the discharge pipe 99 may be shaped into a wave. In the following, only the left edge 99b of the discharge pipe 99 will be described, and the description of the right edge 99a of the discharge pipe 99 will be omitted.

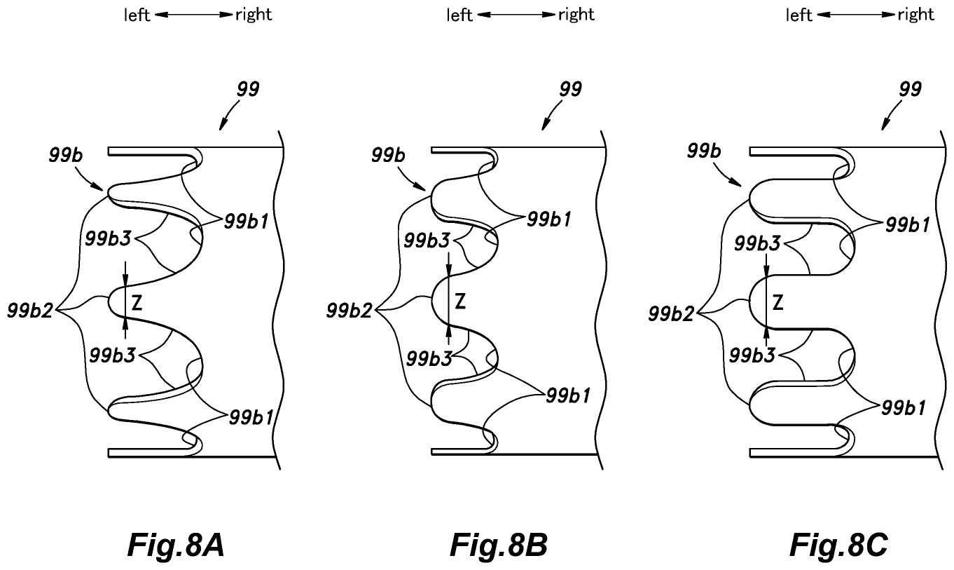

With reference to FIGS. 8A to 8C, on the left edge 99b of the discharge pipe 99, a plurality of first curving portions 99b1 and a plurality of second curving portions 99b2 are formed alternately in the circumferential direction of the discharge pipe 99. The first curving portions 99b1 are recessed to a right side (upstream side), and the second curving portions 99b2 protrude to a left side (downstream side). In the first example (see FIG. 8A) of the discharge pipe 99, the radius of curvature of each second curving portion 99b2 is smaller than that of each first curving portion 99b1. On the other hand, in the second example (see FIG. 8B) and the third example (see FIG. 8C) of the discharge pipe 99, the radius of curvature of each second curving portion 99b2 is equal to or greater than that of each first curving portion 99b1.

With reference to FIGS. 8A to 8C, on the left edge 99b of the discharge pipe 99, a plurality of connecting portions 99b3 connecting the first curving portions 99b1 and the second curving portions 99b2 are formed. In the first example (see FIG. 8A) and the second example (see FIG. 8B) of the discharge pipe 99, each connecting portion 99b3 inclines relative to the lateral direction (longitudinal direction of the discharge pipe 99). On the other hand, in the third example (see FIG. 8C) of the discharge pipe 99, each connecting portion 99b3 is parallel to the lateral direction.

### <Flow of the Exhaust Gas>

When the engine 1 is driven, the exhaust gas is discharged from the exhaust ports 19 of the first and second cylinder banks 8 and 9. The exhaust gas discharged from the exhaust ports 19 passes through the first and second exhaust pipes 31, 32, and then flows into the inlet tubular body 51 of the catalyst pipe 34 via the first and second inlet ports 58, 59. The exhaust gas that has flowed into the inlet tubular body 51 of the catalyst pipe 34 passes through the inlet tubular body 51, the inner tubular body 52, and the outlet tubular body 53 of the catalyst pipe 34 in this order, and is then discharged from the outlet tubular body 53 of the catalyst pipe 34 via the outlet port 66. In this way, the exhaust gas passes through the catalyst pipe 34, and thus the exhaust gas is purified by the catalyst 33 accommodated in the catalyst pipe 34.

The exhaust gas discharged from the outlet tubular body 53 of the catalyst pipe 34 flows into the inflow pipe 97 of the muffler 41. The exhaust gas that has flowed into the inflow pipe 97 passes through the inflow pipe 97, and then flows into the first muffling chamber 111 of the muffler 41 via the inflow port 109. The exhaust gas that has flowed into the first muffling chamber 111 passes through the first muffling chamber 111, and then flows into the communication pipe 98 of the muffler 41 via the communication port 121. The exhaust gas that has flowed into the communication pipe 98 passes through the communication pipe 98, and then flows into the second muffling chamber 112 of the muffler 41 via the multiple communication holes 123. The exhaust gas that has flowed into the second muffling chamber 112 passes through the second muffling chamber 112, and then flows into the third muffling chamber 113 of the muffler 41 via the multiple small holes 115 of the second partition wall 96. The exhaust gas that has flowed into the third muffling chamber 113 passes through the third muffling chamber 113, and then flows into the discharge pipe 99 of the muffler 41 via the multiple outer circumferential holes 127. The exhaust gas that has flowed into the discharge pipe 99 passes through the discharge pipe 99, and is then discharged from the opening 125 formed at the left end of the discharge pipe 99 to the external space S on the left side of the muffler body 94. In this way, the exhaust gas passes through the muffler 41, and thus the exhaust sound is reduced.

### <Effect of the First Embodiment>

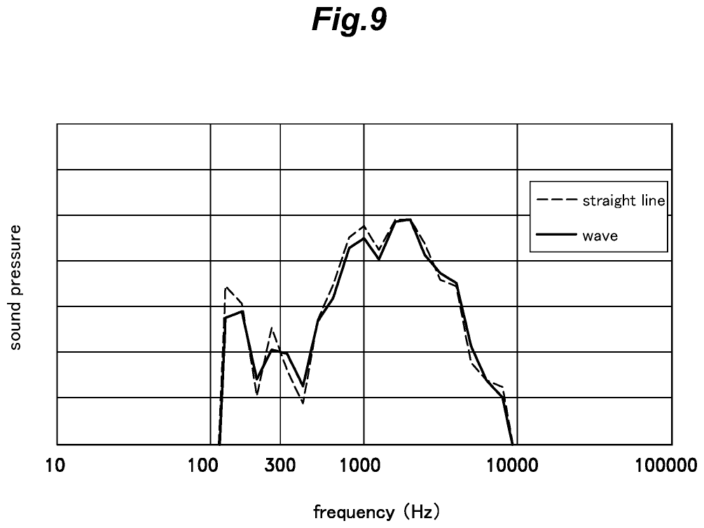

FIG. 9 shows a relationship between frequency and sound pressure (noise level) for each shape of the left edge 99b (downstream edge) of the discharge pipe 99 when the engine 1 is driven. As shown in FIG. 9, in a case where the left edge 99b of the discharge pipe 99 is shaped into a wave, the peak of sound pressure decreases in a low frequency area (for example, an area of 300 Hz or less) as compared with a case where the left edge 99b of the discharge pipe 99 is shaped into a straight line. In this way, by shaping the left edge 99b of the discharge pipe 99 into a wave, it is possible to effectively attenuate a low frequency component (that is, a component having a relatively low frequency) of the exhaust sound of the engine 1.

Further, since it is possible to attenuate the low frequency component of the exhaust sound by shaping the left edge 99b of the discharge pipe 99 into a wave, it is not necessary to increase the volumes of the muffling chambers 111 to 113 to attenuate the low frequency component of the exhaust sound. Accordingly, it is possible to suppress an increase in the size of the muffler 41.

Further, the left edge 99b of the discharge pipe 99 protrudes to the left side (one side in the longitudinal direction) of the muffler body 94. According to such a configuration, it is possible to prevent the left edge 99b of the discharge pipe 99 from protruding from an outer circumferential surface of the tubular portion 101 of the muffler body 94. Accordingly, it is possible to more effectively suppress an increase in the size of the muffler 41.

Further, the discharge pipe 99 penetrates the muffler body 94 to protrude to both lateral sides (both sides in the longitudinal direction) of the muffler body 94, and the pair of openings 125 are provided at both lateral ends of the discharge pipe 99. According to such a configuration, by closing the opening 125 formed at the right end of the discharge pipe 99, it is possible to discharge the exhaust gas to a left side of the muffler body 94. Further, by closing the opening 125 formed at the left end of the discharge pipe 99, it is possible to discharge the exhaust gas to a right side of the muffler body 94. Furthermore, by closing neither opening 125, it is possible to discharge the exhaust gas to both lateral sides of the muffler body 94. That is, the direction in which the exhaust gas is discharged can be flexibly selected from the left side, the right side, and both lateral sides of the muffler body 94.

In the present embodiment, the opening 125 formed at the right end of the discharge pipe 99 is closed by the lid member 126. According such a configuration, it is possible to determine the direction in which the discharge pipe 99 discharges the exhaust gas with a simple configuration.

Further, the first curving portions 99b1 and the second curving portions 99b2 are alternately formed on the left edge 99b of the discharge pipe 99. According to such a configuration, a corner (a sharp portion) is not formed on the left edge 99b of the discharge pipe 99. Accordingly, even if the left edge 99b of the discharge pipe 99 comes into contact with other parts at the attachment of the muffler 41 or the like, the left edge 99b of the discharge pipe 99 is less likely to deform.

Further, in the first example of the discharge pipe 99 (see FIG. 8A), the radius of curvature of each second curving portion 99b2 is smaller than that of each first curving portion 99b1. According to such a configuration, circumferential distances between the second curving portions 99b2 become wider, so that the left edge 99b of the discharge pipe 99 can be easily shaped into a wave.

On the other hand, in the second example (see FIG. 8B) and the third example (see FIG. 8C) of the discharge pipe 99, the radius of curvature of each second curving portion 99b2 is equal to or greater than that of each first curving portion 99b1. According to such a configuration, the circumferential width Z of each second curving portion 99b2 increases. Thus, each second curving portion 99b2 is less likely to deform even if each second curving portion 99b2 comes into contact with other parts at the attachment of the muffler 41 or the like.

In the present embodiment, the abovementioned muffler 41 is applied to an air-cooled engine. In general, an air-cooled engine is smaller than a water-cooled engine or the like, and thus the abovementioned small muffler 41 having a high muffling performance is suitable for the air-cooled engine.

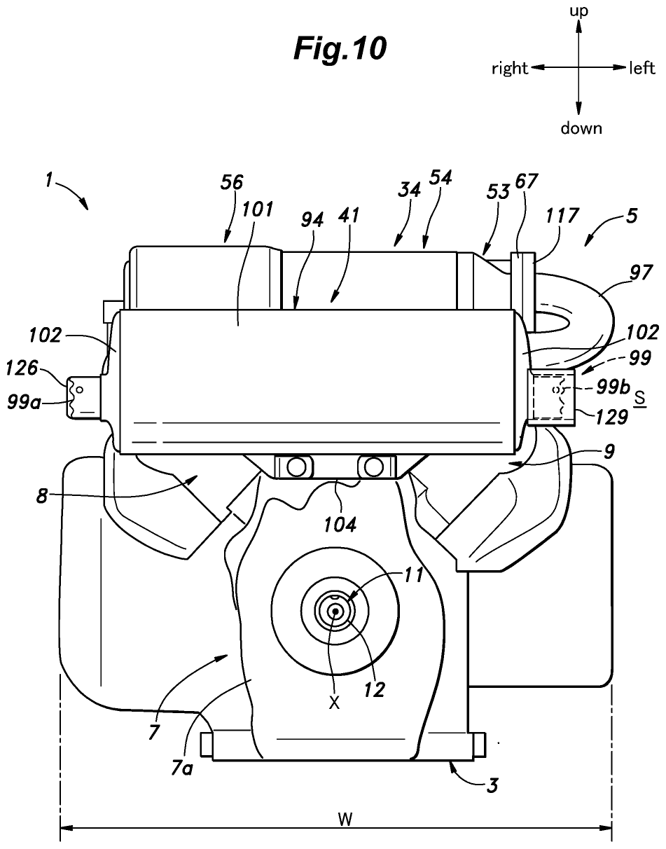

Incidentally, in the present embodiment, the left edge 99b (downstream edge) of the discharge pipe 99 is exposed. In another embodiment, as shown in FIG. 10, an outer circumference of the left edge 99b of the discharge pipe 99 may be covered with a cover 129. According to such a configuration, it is possible to suppress the damage of the left edge 99b of the discharge pipe 99 and enhance the muffling effect.

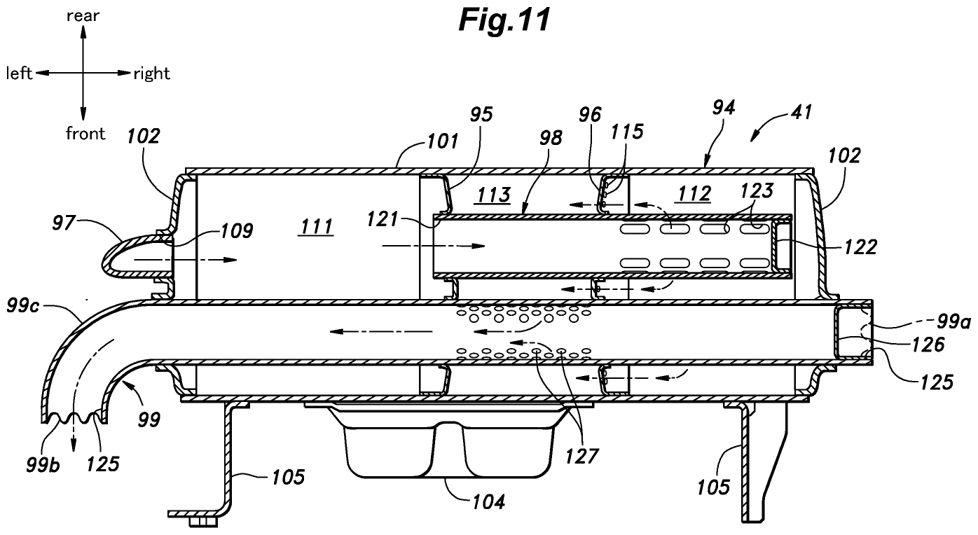

Further, in the present embodiment, the entire discharge pipe 99 extends linearly in the lateral direction. In another embodiment, as shown in FIG. 11, the discharge pipe 99 may be bent at a portion 99c protruding to a left side or a right side (one side in the longitudinal direction) of the muffler body 94. According to such a configuration, the flexibility in the direction in which the discharge pipe 99 discharges the exhaust gas can be enhanced, so that the usability of the work machine P on which the muffler 41 is installed is improved.

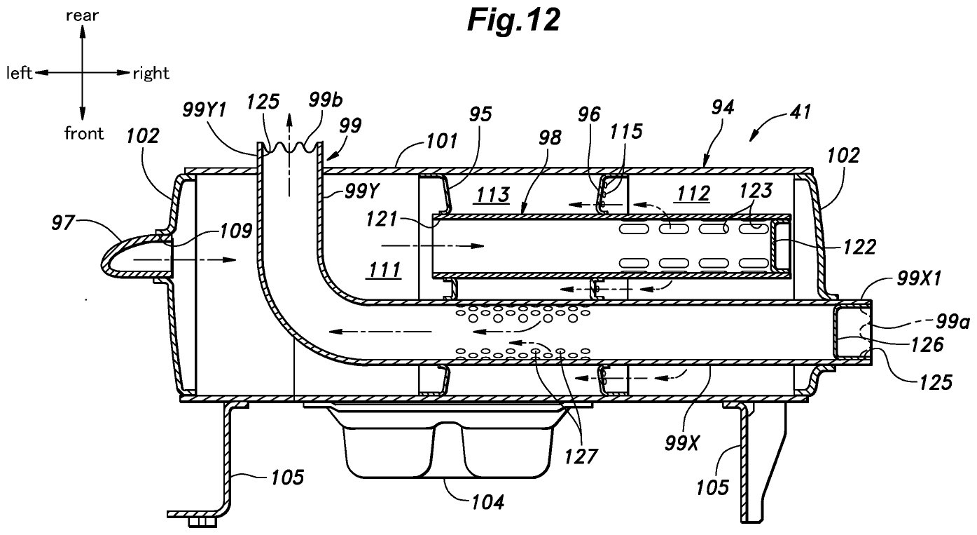

Furthermore, in still another embodiment, as shown in FIG. 12, the discharge pipe 99 may include a first pipe portion 99X and a second pipe portion 99Y. The first pipe portion 99X extends in the lateral direction (longitudinal direction of the muffler body 94), and penetrates one of the lid portions 102 to protrude from the muffler body 94. The second pipe portion 99Y is bent from the first pipe portion 99X inside the muffler body 94, extends in the front-and-rear direction, and penetrates the tubular portion 101 to protrude from the muffler body 94. An opening 125 is provided in a protruding portion 99X1, 99Y1 (a portion protruding from the muffler body 94) of each of the first and second pipe portions 99X, 99Y. According to such a configuration, the flexibility in the direction in which the discharge pipe 99 discharges the exhaust gas can be enhanced, so that the usability of the work machine P on which the muffler 41 is installed is improved.

### The Second Embodiment

### <V-Type Engine 131>

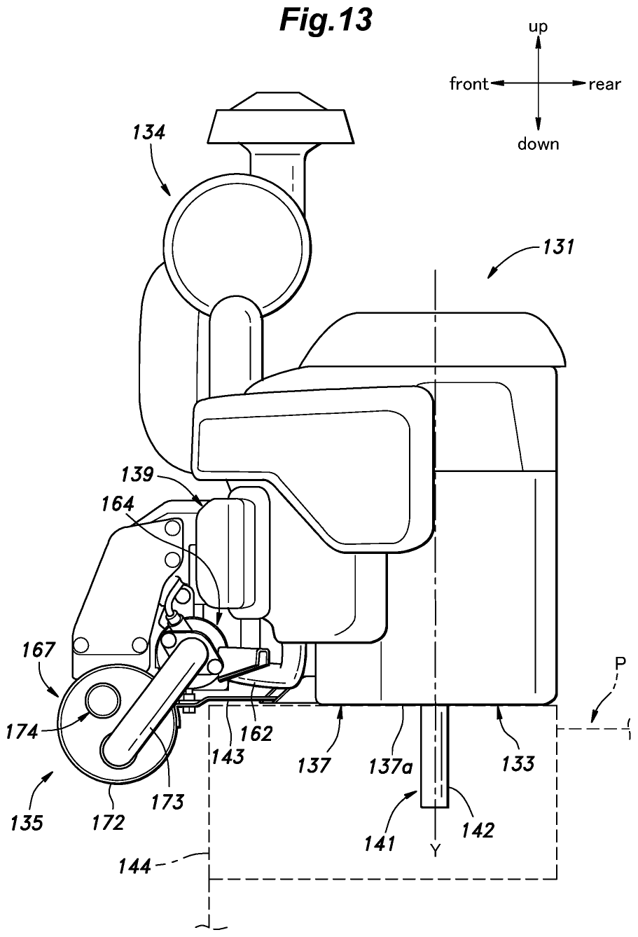

In the following, a vertical V-type engine 131 (hereinafter abbreviated as “engine 131”) according to the second embodiment of the present invention will be described with reference to FIGS. 13 to 16. Hereinafter, for convenience of explanation, a left side in FIG. 13 is defined as a front side of the engine 131. The descriptions overlapping with those of the first embodiment will be omitted as appropriate.

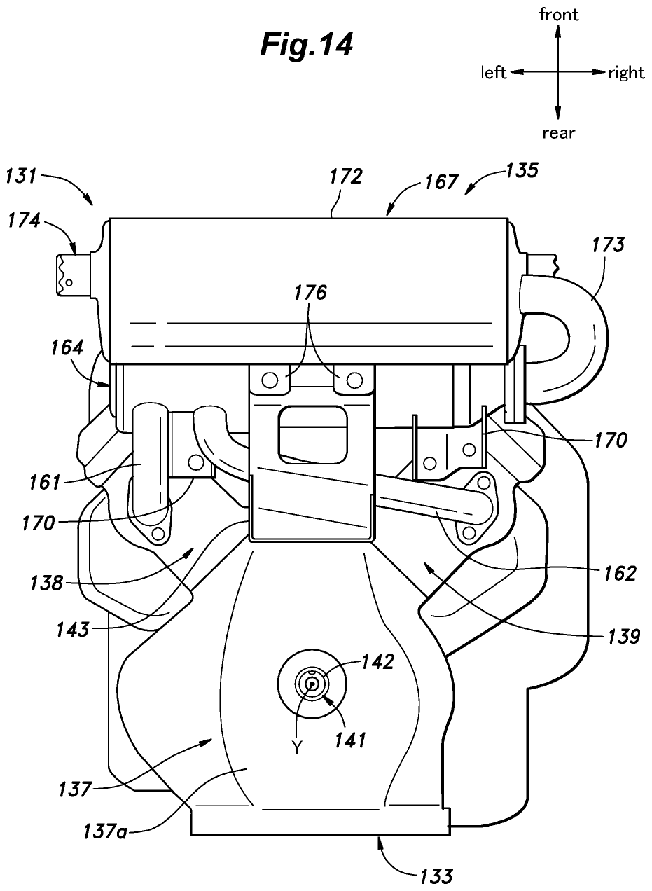

With reference to FIGS. 13 and 14, the engine 131 includes an engine body 133, an air cleaner 134 arranged above the engine body 133, and an exhaust device 135 arranged on a lower front side of the engine body 133. In the following, these components of the engine 131 will be described in order.

### <Engine Body 133>

With reference to FIGS. 13 and 14, the engine body 133 includes a crankcase 137, a first cylinder bank 138 extending to a left front side from the crankcase 137, and a second cylinder bank 139 extending to a right front side from the crankcase 137.

A crankshaft 141 is rotatably supported by a central portion of the crankcase 137. The crankshaft 141 is configured to rotate around a rotation axis Y extending in the up-and-down direction. That is, the engine 131 consists of a vertical engine in which the rotation axis Y of the crankshaft 141 extends in the up-and-down direction. A power take-off shaft 142 (PTO shaft: an example of an output portion) is provided at a lower end of the crankshaft 141. The PTO shaft 142 protrudes downward from a lower surface 137a of the crankcase 137 and extends in the up-and-down direction. An attachment member 143 is fixed to a lower portion of a front surface of the crankcase 137 by a pair of left and right bolts (not shown).

An engine mount 144 is arranged below the crankcase 137. The crankcase 137 is attached to the work machine P via the engine mount 144. For example, the work machine P is a riding-type lawn mower.

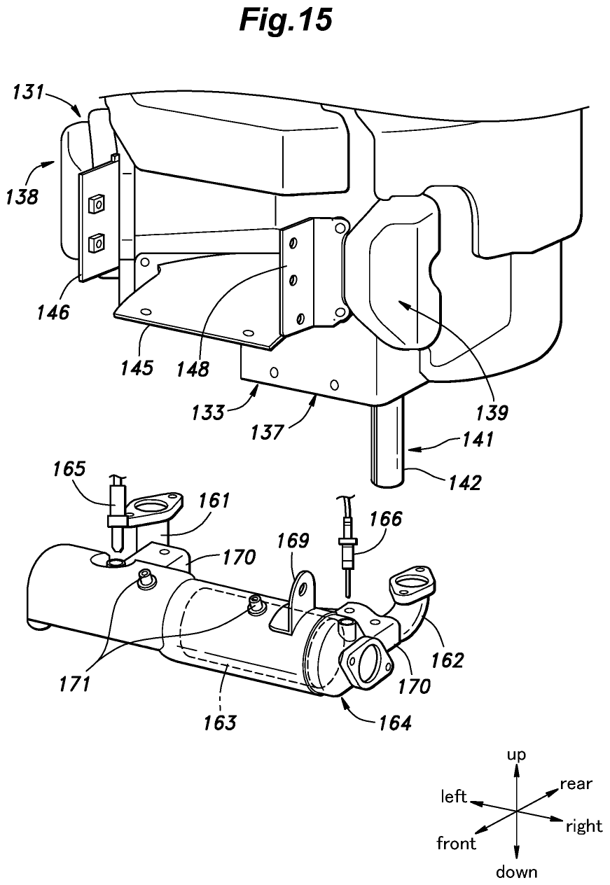

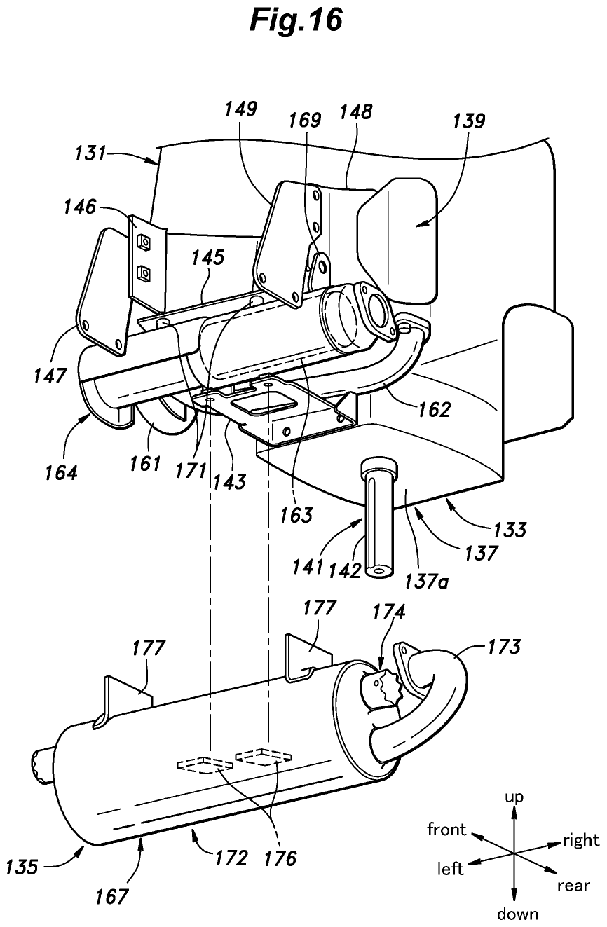

With reference to FIGS. 15 and 16, a support plate 145 (an example of a support member) is fixed to the first and second cylinder banks 138 and 139 by a plurality of bolts (not shown). A first fixed plate 146 is fixed to the first cylinder bank 138 by a pair of bolts (not shown). A first connecting plate 147 is fixed to the first fixed plate 146 by a pair of bolts (not shown). A second fixed plate 148 (an example of a fixed member) is fixed to the second cylinder bank 139 by a pair of bolts (not shown). A second connecting plate 149 is fixed to the second fixed plate 148 by a pair of bolts (not shown).

### <Air Cleaner 134>

With reference to FIG. 13, the air cleaner 134 has a cylindrical shape (canister-like shape) extending in the lateral direction. The air cleaner 134 is not arranged between the first and second cylinder banks 138 and 139 of the engine body 133, and arranged higher than the first and second cylinder banks 138 and 139.

### <Exhaust Device 135>

With reference to FIGS. 15 and 16, the exhaust device 135 includes first and second exhaust pipes 161, 162, a catalyst 163, a catalyst pipe 164, an oxygen sensor 165, a temperature sensor 166, and a muffler 167.

### <Catalyst Pipe 164>

With reference to FIG. 13, the catalyst pipe 164 of the exhaust device 135 is arranged on a front side of the first and second cylinder banks 138 and 139 and separated from the air cleaner 134 in the up-and-down direction. The catalyst pipe 164 is arranged higher than the lower surface 137a of the crankcase 137.

With reference to FIGS. 15 and 16, in a right portion (one side portion in the longitudinal direction) of an outer circumferential surface of the catalyst pipe 164, a fixed stay 169 protrudes upward. The fixed stay 169 is fixed to the second fixed plate 148 by a bolt (not shown). In both lateral portions (both side portions in the longitudinal direction) on an outer circumferential surface of the catalyst pipe 164, a pair of left and right fixed pieces 170 protrude rearward. The left fixed piece 170 is fixed to the first cylinder bank 138 by a bolt (not shown). The right fixed piece 170 is fixed to the second cylinder bank 139 by a pair of bolts (not shown). In both lateral portions on the outer circumferential surface of the catalyst pipe 164, a pair of bosses 171 are provided. The pair of bosses 171 are fixed to the support plate 145 by a pair of bolts (not shown).

### <Muffler 167>

With reference to FIG. 16, like the muffler 41 according to the first embodiment, the muffler 167 of the exhaust device 135 includes a muffler body 172, a plurality of partition walls (not shown), an inflow pipe 173, a communication pipe (not shown), and a discharge pipe 174.

In a laterally central portion on an outer circumferential surface of the muffler body 172, a pair of left and right fixed brackets 176 protrude rearward. The pair of left and right fixed brackets 176 are fixed to the attachment member 143 by a pair of left and right bolts (not shown). In both left and right portions on the outer circumferential surface of the muffler body 172, a pair of left and right fixed stays 177 protrude upward. The left fixed stay 177 is fixed to the first connecting plate 147 by a pair of bolts (not shown). The right fixed stay 177 is fixed to the second connecting plate 149 by a pair of bolts (not shown).

### <Effect of the Second Embodiment>

The PTO shaft 142 protrudes from the lower surface 137a of the crankcase 137, and the catalyst pipe 164 is arranged higher than the lower surface 137a of the crankcase 137. According to such a configuration, in the vertical engine 131, it is possible to prevent the catalyst pipe 164 from protruding lower than the lower surface 137a of the crankcase 137. Accordingly, it is possible to prevent the catalyst pipe 164 from interfering with the engine mount 144.

Further, the fixed stay 169 fixed to the second fixed plate 148 is provided in a right portion (one side portion in the longitudinal direction) of the catalyst pipe 164, and the pair of left and right fixed pieces 170 fixed to the first and second cylinder banks 138 and 139 and the pair of left and right bosses 171 fixed to the support plate 145 are provided on both lateral sides (both sides in the longitudinal direction) of the catalyst pipe 164. According to such a configuration, the catalyst pipe 164 can be fixed to the engine body 133 in a well-balanced manner with a simple configuration. Accordingly, it is not necessary to fix the catalyst pipe 164 to a frame around the engine body 133, so that the fixing operation of the catalyst pipe 164 can be facilitated.

Concrete embodiments of the present invention have been described in the foregoing, but the present invention should not be limited by the foregoing embodiments and various modifications and alterations are possible within the scope of the present invention.

1. A muffler for an engine, comprising:
a muffler body provided with a muffling chamber;
a discharge pipe configured to discharge exhaust gas that has passed through the muffling chamber to an external space,
wherein a downstream edge of the discharge pipe in an exhaust direction is shaped into a wave that is continuous in a circumferential direction.

2. The muffler according to claim 1, wherein the downstream edge of the discharge pipe in the exhaust direction protrudes to one side of the muffler body in a longitudinal direction thereof.

3. The muffler according to claim 1, wherein the discharge pipe extends in a longitudinal direction of the muffler body and penetrates the muffler body to protrude to both sides of the muffler body in the longitudinal direction thereof, and
a pair of openings are provided at both ends of the discharge pipe in a longitudinal direction thereof.

4. The muffler according to claim 3, wherein the discharge pipe is bent at a portion protruding to one side of the muffler body in the longitudinal direction thereof.

5. The muffler according to claim 1, wherein the muffler body includes:
a tubular portion extending in a longitudinal direction of the muffler body: and
a pair of lid portions covering openings at both ends of the tubular portion,
the discharge pipe includes:
a first pipe portion extending in the longitudinal direction of the muffler body and penetrating one of the lid portions to protrude from the muffler body; and
a second pipe portion bent from the first pipe portion inside the muffler body and penetrating the tubular portion to protrude from the muffler body, and
an opening is provided in a protruding portion of each of the first pipe portion and the second pipe portion, the protruding portion protruding from the muffler body.

6. The muffler according to claim 3, wherein the downstream edge of the discharge pipe in the exhaust direction is provided on an outer circumference of one of the openings, and
another of the openings is closed by a lid member.

7. The muffler according to claim 1, wherein an outer circumference of the downstream edge of the discharge pipe in the exhaust direction is covered with a cover.

8. The muffler according to claim 1, wherein a plurality of first curving portions and a plurality of second curving portions are alternately formed on the downstream edge of the discharge pipe in the exhaust direction, the first curving portions being recessed to an upstream side in the exhaust direction, the second curving portions protruding to a downstream side in the exhaust direction.

9. The muffler according to claim 8, wherein a radius of curvature of the second curving portions is smaller than a radius of curvature of the first curving portions.

10. The muffler according to claim 8, wherein a radius of curvature of the second curving portions is equal to or greater than a radius of curvature of the first curving portions.

11. An air-cooled engine, comprising the muffler according to claim 1.

12. A work machine, comprising the muffler according to claim 1.

13. A work machine, comprising the air-cooled engine according to claim 11.
